(19) United States
(12) Patent Application Publication
(10) Pub. No.: US 2012/0001811 A1
(43) Pub. Date: Jan. 5, 2012

(54) VEHICLE ANTENNA

(75) Inventors: Tae-Hwan Yoo, Seoul (KR); Byong-Nam Kim, Bucheon (KR); Seung-Yong Lee, Bucheon (KR); Han-Soo Park, Goyang (KR); Sung-Bok Cho, Seoul (KR)

(73) Assignee: ACE TECHNOLOGIES CORPORATION, Incheon (KR)

(21) Appl. No.: 13/233,642

(22) Filed: Sep. 15, 2011

Related U.S. Application Data
(63) Continuation of application No. PCT/KR2010/001680, filed on Mar. 18, 2010.

(30) Foreign Application Priority Data
Mar. 19, 2009 (KR) 10-2009-0023358

(51) Int. Cl. H01Q 1/32

(52) U.S. Cl. 343/713

(57) ABSTRACT

An antenna for a vehicle for enabling to design freely and enhance characteristics of the antenna such as isolation, etc. is disclosed. The antenna includes a substrate and a case configured to cover the substrate. Here, one or more radiator is disposed on an outer surface of the case, and a power is fed to the radiator from the substrate.

### CROSS-REFERENCE TO RELATED APPLICATION

This application is a continuation of PCT/KR2010/001680 filed Mar. 18, 2010, which claims the benefit of Korean Application No. 10-2009-0023358 filed Mar. 19, 2009, the entire contents of which applications are incorporated herein by reference.

### TECHNICAL FIELD

Example embodiment of the present invention relates to an antenna for a vehicle, more particularly relates to an antenna for a vehicle in which a radiator is formed on an outer surface of a case.

### BACKGROUND ART

Since many communication devices such as a radio, a DMB and a navigation device, etc. exist in a vehicle, it is necessary to set antennas for the communication devices to the vehicle. Accordingly, the antennas are set inside and outside of the vehicle.

An internal antenna includes a sticker typed film antenna or a glass antenna established on a glass of the vehicle, etc. However, it is difficult to receive a GPS signal, a TDMB signal, etc. through the internal antenna due to receiving rate and size of a reception module. Accordingly, an external antenna having shark shape, i.e. shark antenna shown in FIG. 1 has been developed to receive the signals.

FIG. 1 is a view illustrating a common antenna for a vehicle, and FIG. 2 is a perspective view illustrating a common shark antenna.

As shown in FIG. 1, a shark antenna 104 is formed with shark's fin shape on a roof of a vehicle 102.

The shark antenna 104 is composed of a GPS antenna 204 and a TDMB antenna 206 fixed on a base 200 in the case 202 as shown in FIG. 2.

The TDMB antenna 206 is embodied with a helical antenna due to frequency characteristics of a TDMB signal, and so the shark antenna 104 should have structure of rising vertically like the shark's fin. The shark's fin shape of the shark antenna 104 harmonizes with some of vehicles, but does not harmonize with other vehicles. Nevertheless, the shark antenna 104 should be embodied with shark's fin shape due to the frequency characteristics. That is, it is limited to design the vehicle due to the shape of the shark antenna 104

In addition, since the GPS antenna 204, the TDMB antenna 206 and other internal elements are concentrated in the case 202, the antenna 204 or 206 is interfered by the other antenna 206 or 204 or the other elements. As a result, an isolation characteristic, etc. may be deteriorated.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

An example embodiment of the present invention provides an antenna for a vehicle for enabling to design freely the vehicle and enhance characteristics of the antenna such as isolation, etc. by improving space utilization.

In one aspect, the present invention provides an antenna for a vehicle comprising: a substrate; and a case configured to cover the substrate. Here, one or more radiator is disposed on an outer surface of the case, and a power is fed to the radiator from the substrate.

A first coupling side connected electrically to the radiator is formed on the outer surface of the case, and a second coupling side connected electrically to the substrate is formed on an inner surface of the case. Here, the power fed from the substrate is provided to the radiator through the coupling sides according to a coupling method.

The radiator is formed on the outer surface of the case with spiral shape or zigzag shape.

The antenna further includes a feeding member longitudinal-extended from the substrate in the direction to the case from the substrate; and a connection member longitudinal-extended from an inner surface to the outer surface of the case, and connected electrically to the radiator. Here, the connection member is electrically connected to the feeding member on the inner surface of the case.

The antenna further includes a feeding member longitudinal-extended from the substrate in the direction to the case from the substrate. Here, a hole is formed through the case, and the feeding member is electrically connected to the radiator through the hole.

A hole is formed through the case and is filled with a metal member. Here, one end of the metal member is electrically connected to the radiator, and the other end of the metal member is electrically connected to a feeding member extended from the substrate.

In another aspect, the present invention provides an antenna for a vehicle comprising: a case; a first radiator disposed on an outer surface of the case; and a second radiator disposed on the outer surface of the case and separated electrically from the first radiator.

A first coupling side is formed on the outer surface of the case, and a second coupling side is formed on an inner surface of the case. Here, a power is fed to the first radiator through the coupling sides according to an electromagnetic coupling method.

The antenna further includes a substrate; and a feeding member longitudinal-extended from the substrate in the direction to the case from the substrate. Here, the second radiator is directly connected to the feeding member through a hole of the case or is electrically connected to the feeding member through a connection member or a metal member.

The first radiator is formed on the outer surface of the case with spiral shape or zigzag shape.

In an antenna for a vehicle of the present invention, one or more radiators are formed on an outer surface of a case, and so space utilization of the antenna may be enhanced. As a result, the number of elements in the case reduces, and thus interference between the elements in the case may decrease, and isolation between the radiator formed on the outer surface of the case and the elements in the case may be enhanced.

In addition, since for example a TDMB antenna is formed on the outer surface of the case, the antenna for the vehicle may not be embodied with shark's fin shape unlike the conventional antenna which should have only shark's fin shape. That is, the antenna may have various shapes, and so design of the vehicle may be gentrified by designing freely the antenna of the vehicle with proper shape according to shape of the vehicle.

Furthermore, since a plurality of radiators is formed on the outer surface of the case, the antenna may realize more many frequency bands compared to the conventional antenna.

Moreover, the radiator may be formed with adequate length on the outer surface of the case, the antenna may realize frequency band lower than the conventional antenna.

### BRIEF DESCRIPTION OF DRAWINGS

Example embodiments of the present invention will become more apparent by describing in detail example embodiments of the present invention with reference to the accompanying drawings, in which:

FIG. 1 is a view illustrating a common antenna for a vehicle;

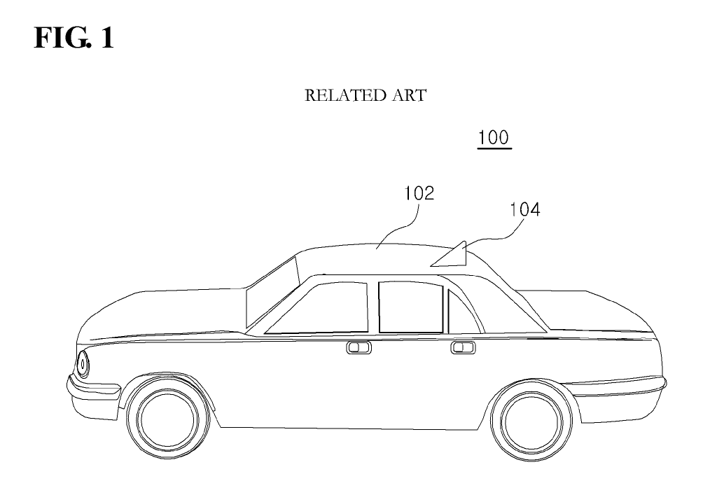

FIG. 2 is a perspective view illustrating a common shark antenna;

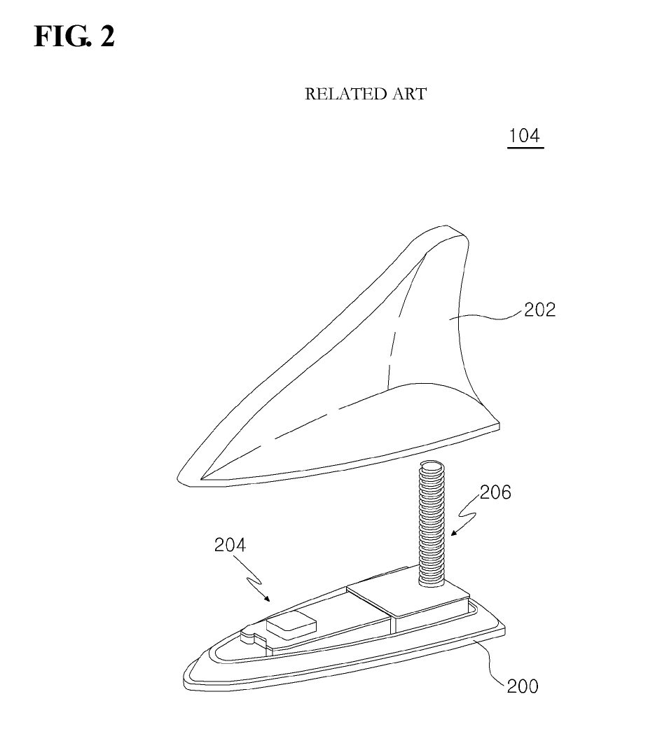

FIG. 3 is a perspective view illustrating external appearance of an antenna for a vehicle according to one example embodiment of the present invention;

FIG. 4 is a sectional view illustrating structure of a case according to one example embodiment of the present invention;

FIG. 5 is a perspective view illustrating feeding structure of an antenna for a vehicle according to a first embodiment of the present invention;

FIG. 6 is a sectional view illustrating feeding structure of an antenna for a vehicle according to a second embodiment of the present invention;

FIG. 7 is a sectional view illustrating feeding structure of an antenna for a vehicle according to a third embodiment of the present invention; and

FIG. 8 is a sectional view illustrating feeding structure of an antenna for a vehicle according to a fourth embodiment of the present invention.

### DETAILED DESCRIPTION OF THE DISCLOSURE

Hereinafter, embodiments of the present invention will be described in detail with reference to accompanying drawings.

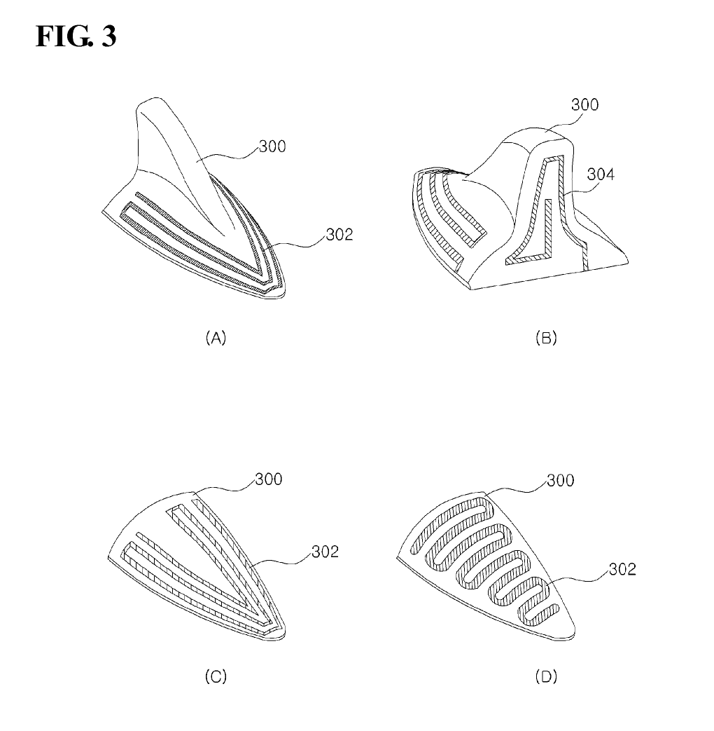

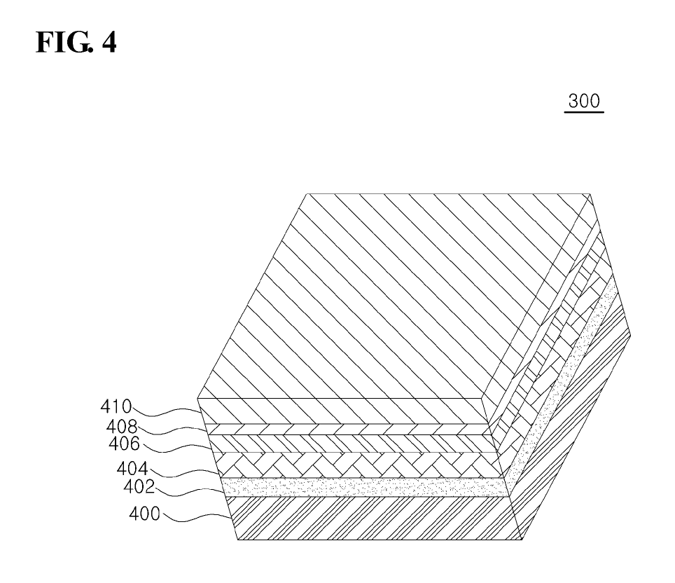

FIG. 3 is a perspective view illustrating external appearance of an antenna for a vehicle according to one example embodiment of the present invention, and FIG. 4 is a sectional view illustrating structure of a case according to one example embodiment of the present invention.

The antenna for the vehicle of the present invention as an outside antenna transmits/receives a RF signal in a GPS frequency band, a TDMB frequency band, an UMTS frequency band, etc., and may be set generally on a roof of the vehicle.

In FIG. 3(A), the antenna of the present invention includes a case 300 and a first radiator 302.

The case 300 protects elements in the antenna by covering the elements, and may have streamlined shape, e.g. shark's fin shape. The case 300 functions as a carrier. In one embodiment of the present invention, the case 300 may include a plastic layer 400, a copper layer 402, a PET film layer 404, a bonding seat layer 406, an ink layer 408 and a PET film layer 410 as shown in FIG. 4. However, structure and shape of the case 300 is not limited as the structure and the shape shown in FIG. 3 and FIG. 4.

The first radiator 302 is formed on an outer surface of the case 300, and is made up of a conductor, e.g. copper. Preferably, the first radiator 302 is embodied with spiral shape on the case 300 as shown in FIG. 3(A). Here, a power is fed to the first radiator 302 from a substrate in the case 300, which is not shown in FIG. 3(A). The feeding of the power may be variously modified. This will be described in detail with reference to accompanying drawings.

Since the case 300 on which the first radiator 302 is formed has streamlined shape, the first radiator 302 may transmit/receive horizontally an electromagnetic wave and transmit/receive vertically the electromagnetic wave according to height of the case 300. That is, the first radiator 302 may transmit/receive sterically the electromagnetic wave on the outer surface of the case 300, i.e. have half-spherical shape of directivity.

In one embodiment of the present invention, the antenna may include further a second radiator 304 as shown in FIG. 3(B). The second radiator 304 may realize an UMTS frequency band while the first radiator 302 achieves the TDMB frequency band.

In brief, in the antenna for the vehicle of the present embodiment, at least one radiator, e.g. two radiators 302 and 304 may be formed on the outer surface of the case 300. Accordingly, the antenna may realize multi band.

Another radiator may be formed on an inner surface of the case 300, which is not described above.

In one embodiment of the present invention, the radiators 302 and 304 may be formed on the outer surface of the case 300 through a printing method, and so the antenna may embody more easily the radiators 302 and 304 compared to the conventional antenna.

The antenna of the present embodiment may realize more many multi band compared with the conventional antenna in which an antenna for the TDMB frequency band locates in a case. For example, the conventional antenna realizes only the GPS frequency band and the TDMB frequency band, but the antenna of the present embodiment may achieve the GPS frequency band, the TDMB frequency band and the UMTS frequency band.

In addition, in the conventional antenna, a radiator for the GPS frequency band, a radiator for the TDMB frequency band and many other internal elements are concentrated in the case, and so considerable interference occurs among the radiators and the elements. As a result, characteristics of a GPS antenna or a TDMB antenna, e.g. isolation may be deteriorated. However, since the radiators 302 and 304 for the TDMB frequency band and the UMTS frequency band are formed on the outer surface of the case 300, the number of internal elements in the case 300 reduces and so interference among the internal elements may reduce. Additionally, interference between the radiators 302 and 304 and the internal elements reduces and thus isolation characteristic, etc. may be enhanced.

In above description, the radiators 302 and 304 realize only one frequency band, respectively. However, the radiators 302 and 304 may realize two or more frequency bands, respectively.

Furthermore, the antenna of the present embodiment has shark shape, but may have streamlined shape as shown in FIG. 3(C) and FIG. 3(D). This is because the antenna may not be embodied with helical type, thereby enabling to design variously height of the antenna. In other words, the antenna for the vehicle of the present embodiment may be embodied with various shapes, and thus the antenna may be designed with proper shape according to shape of the vehicle. As a result, esthetic characteristics of the vehicle may be enhanced and the design of the vehicle may be gentrified.

Since the antenna does not have shark's fin shape in FIG. 3(C), the first radiator 302 in FIG. 3(C) may be formed with length longer than that in FIG. 3(A). As a result, the first radiator 302 in FIG. 3(C) may realize more low frequency band.

In FIG. 3(D), the first radiator 302 may be embodied with zigzag shape not spiral shape on the outer surface of the case 300.

That is, pattern of the radiators 302 and 304 may be variously modified as long as they are formed on the outer surface of the case 300.

Hereinafter, feeding structure in the antenna for the vehicle of the present invention will be described in detail with reference to accompanying drawings. Here, a power may be fed to both of the first radiator 302 and the second radiator 304 from a substrate. However, hereinafter it will be assumed that the power is fed to the first radiator 302 for convenience of description.

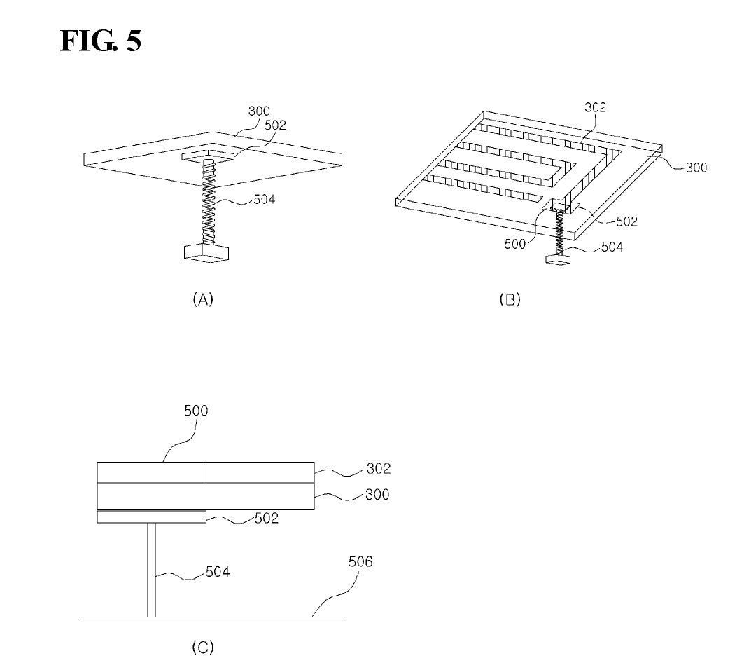

FIG. 5 is a perspective view illustrating feeding structure of an antenna for a vehicle according to a first embodiment of the present invention.

In FIG. 5(A) to FIG. 5(C), a first coupling side 500 is formed on the outer surface of the case 300, and a second coupling side 502 is formed on a location facing to the first coupling side 500 of the inner surface of the case 300. Here, each of the coupling sides 500 and 502 is a conductor.

The first coupling side 500 is electrically connected to for example the first radiator 302 as shown in FIG. 5(B). Here, the case 300 has streamlined shape in FIG. 3, but FIG. 5(B) shows only part of the case 300 to have plane shape for convenience of description.

The second coupling side 502 is connected to a feeding member 504. Here, the feeding member 504 is a conductor, and is electrically connected to a substrate 506, e.g. PCB as shown in FIG. 5(C). Accordingly, a power fed from the substrate 500 is delivered to the second coupling side 502 through the feeding member 504, and the delivered power is provided to the first coupling side 500 through an electromagnetic coupling method. As a result, the power provided from the substrate 506 through the coupling sides 500 and 502 is fed to the first radiator 502, and so the first radiator 302 outputs specific radiation pattern. Here, it is beneficial to enlarge size of the coupling sides 500 and 502 in consideration of coupling amount, but the size of the coupling sides 500 and 502 may be properly set considering total area of the case 300 and other elements because the total area of the case 300 is limited.

In one embodiment of the present invention, a power may be fed to the second radiator 304 by connecting electrically the second radiator 304 to the first coupling side 500 or be fed to the second radiator 304 from the first radiator 302 through the coupling method.

In another embodiment of the present invention, the power is fed to the first radiator 302 from the substrate 506 through the coupling method, and the power may be fed to the second radiator 304 through extra feeding member. Here, the feeding to the second radiator 304 may be achieved through the coupling method or be realized through direct feeding method as described below.

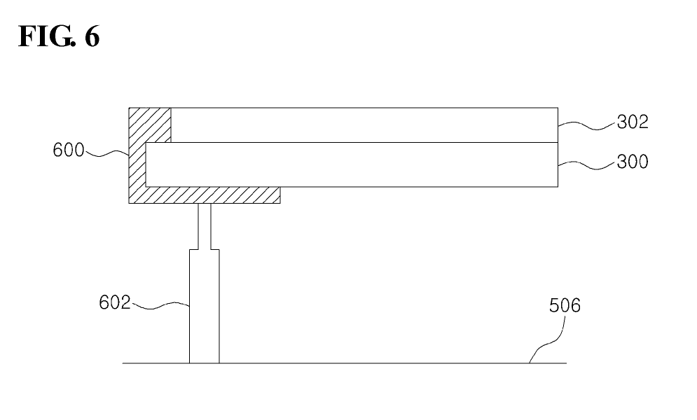

FIG. 6 is a sectional view illustrating feeding structure of an antenna for a vehicle according to a second embodiment of the present invention.

In FIG. 6, the antenna of the present embodiment may include further a connection member 600 extended to the inner surface from the outer surface of the case 300.

The connection member 600 is a conductor, an end of the connection member 600 is electrically connected to a part of the first radiator 302, and the other end of the connection member 600 is electrically connected to a feeding member 602.

Since the feeding member 602 is electrically connected to the substrate 506, a power fed from the substrate 506 is provided to the first radiator 302 formed on the outer surface of the case 300 through the feeding member 602 and the connection member 600.

The above direct feeding method may provide much power to the first radiator 302 compared to the coupling method in the first embodiment. However, since the connection member 600 is extended to the inner surface from the outer surface of the case 300, it may be inconvenient to manufacture the antenna.

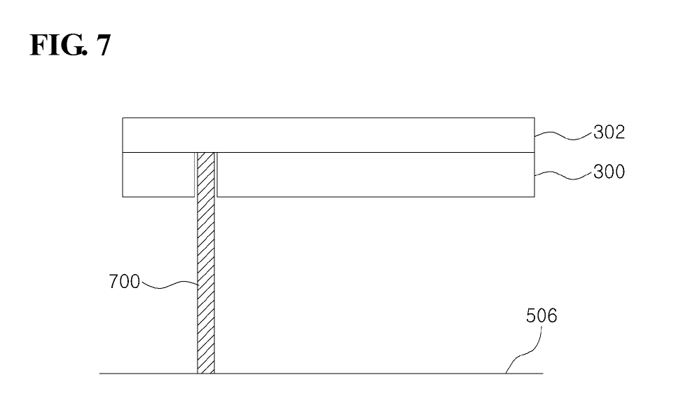

FIG. 7 is a sectional view illustrating feeding structure of an antenna for a vehicle according to a third embodiment of the present invention.

In FIG. 7, in the antenna of the present invention, a hole is formed through the case 300, and a feeding member 700 passes through the hole.

The feeding member 700 is directly connected to the first radiator 302 with extended from the substrate 506.

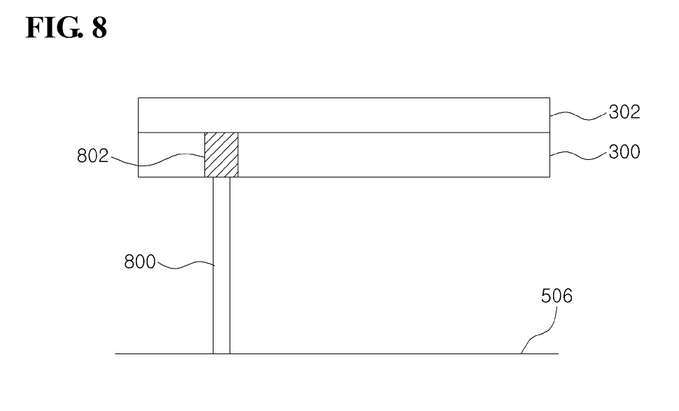

FIG. 8 is a sectional view illustrating feeding structure of an antenna for a vehicle according to a fourth embodiment of the present invention.

In FIG. 8, in the antenna of the present embodiment, a hole is formed through the case 300 and is filled with metal member 802. In other words, the metal member 802 is formed on a part of the case 300.

A feeding member 800 is electrically connected to the metal member 802 from the substrate 506. Here, since the metal member 802 is electrically connected to the first radiator 302, a power fed from the substrate 506 is provided to the first radiator 302 through the feeding member 800 and the metal member 802. As a result, the first radiator 302 outputs specific radiation pattern.

In short, in the antenna for the vehicle of the present invention, one or more radiators are formed on the outer surface of the case with spiral shape, a zigzag shape and so on, and the feeding to the radiator from the substrate may be achieved with various methods such as the coupling method, the direct feeding method, etc.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

1. An antenna for a vehicle comprising:
a substrate; and
a case configured to cover the substrate,
wherein one or more radiator is disposed on an outer surface of the case, and a power is fed to the radiator from the substrate.

2. The antenna of claim 1, wherein a first coupling side connected electrically to the radiator is formed on the outer surface of the case, and a second coupling side connected electrically to the substrate is formed on an inner surface of the case,
and wherein the power fed from the substrate is provided to the radiator through the coupling sides according to a coupling method.

3. The antenna of claim 1, wherein the radiator is formed on the outer surface of the case with spiral shape or zigzag shape.

4. The antenna of claim 1, further comprising:
a feeding member longitudinal-extended from the substrate in the direction to the case from the substrate; and
a connection member longitudinal-extended from an inner surface to the outer surface of the case, and connected electrically to the radiator,
wherein the connection member is electrically connected to the feeding member on the inner surface of the case.

5. The antenna of claim 1, further comprising:
a feeding member longitudinal-extended from the substrate in the direction to the case from the substrate,
wherein a hole is formed through the case, and the feeding member is electrically connected to the radiator through the hole.

6. The antenna of claim 1, wherein a hole is formed through the case and is filled with a metal member,
and wherein one end of the metal member is electrically connected to the radiator, and the other end of the metal member is electrically connected to a feeding member extended from the substrate.

7. An antenna for a vehicle comprising:
a case;
a first radiator disposed on an outer surface of the case; and
a second radiator disposed on the outer surface of the case and separated electrically from the first radiator.

8. The antenna of claim 7, wherein a first coupling side is formed on the outer surface of the case, and a second coupling side is formed on an inner surface of the case,
and wherein a power is fed to the first radiator through the coupling sides according to an electromagnetic coupling method.

9. The antenna of claim 8, further comprising:
a substrate; and
a feeding member longitudinal-extended from the substrate in the direction to the case from the substrate,
wherein the second radiator is directly connected to the feeding member through a hole of the case or is electrically connected to the feeding member through a connection member or a metal member.

10. The antenna of claim 7, wherein the first radiator is formed on the outer surface of the case with spiral shape or zigzag shape.
